(19) United States
(12) Patent Application Publication
(10) Pub. No.: US 2021/0141339 A1
(43) Pub. Date: May 13, 2021

(54) METHOD OF GENERATING MESH-BASED HOLOGRAM

(71) Applicant: ELECTRONICS AND TELECOMMUNICATIONS RESEARCH INSTITUTE, Daejeon (KR)

(72) Inventors: Sang Hoon CHEON, Daejeon (KR); HANJU YEOM, Seoul (KR); Joong-Ki PARK, Daejeon (KR); Kwan-Jung OH, Daejeon (KR); Keehoon HONG, Daejeon (KR)

(73) Assignee: ELECTRONICS AND TELECOMMUNICATIONS RESEARCH INSTITUTE, Daejeon (KR)

(21) Appl. No.: 17/089,977

(22) Filed: Nov. 5, 2020

(30) Foreign Application Priority Data
Nov. 12, 2019 (KR) 10-2019-0144458
Apr. 8, 2020 (KR) 10-2020-0042920

(51) Int. Cl. G03H 1/26

(52) U.S. Cl. CPC G03H 1/268; G03H 2210/30

(57) ABSTRACT

Provided is a hologram generation method including receiving a distribution of a polygon and generating an angular spectrum based on the distribution of the polygon, determining whether a rotation angle of the polygon is included in a first section determined based on a maximum diffraction angle of a spatial light modulator, and recording the angular spectrum if it is determined that the rotation angle is included in the first section.

### CROSS-REFERENCE TO RELATED APPLICATIONS

This U.S non-provisional patent application claims priority under 35 U.S.C. § 119 of Korean Patent Application No. 10−2019−0144458, filed on Nov. 12, 2019, and Korean Patent Application No. 10−2020−0042920, filed on Apr. 8, 2020, the entire contents of which are hereby incorporated by reference.

### BACKGROUND

The present disclosure herein relates to a hologram generation method, and more particularly, to a mesh-based hologram generation method.

Among the technologies for realizing a three-dimensional (3D) stereoscopic image, there are 3D TV using parallax of both eyes, a similar hologram using a mirror, a light-field technology, and a holography technology. Using holography technology, it is possible to actually implement a 3D image. Analog holograms that record still images using particles of several tens of nanometers have excellent color realization and 3D effect, but have a disadvantage that it is difficult to implement moving pictures or digital contents.

Recently, multimedia contents have been developed in a form in which a video realized in computer graphics is synthesized with a real image, or in a form in which the entire contents are computer graphics. In order to implement computer graphics-based content as a hologram, a technology for generating a hologram from a 3D model is required.

As a method of implementing a 3D model as a hologram, there are RGB-Depth (RGB-D) method for dividing a 3D object into sections in the depth direction, a method for expressing and summing a 3D model into a number of points, a mesh method for expressing and adding a 3D model as polygons, and the like.

### SUMMARY

The present disclosure provides a mesh-based hologram generation method that implements a hologram observed similar to a real object.

An embodiment of the inventive concept provides a hologram generation method including: receiving a distribution of a polygon and generating an angular spectrum based on the distribution of the polygon; determining whether a rotation angle of the polygon is included in a first section determined based on a maximum diffraction angle of a spatial light modulator; and recording the angular spectrum if it is determined that the rotation angle is included in the first section.

In an embodiment, the first section may be a section between a value obtained by adding half of the maximum diffraction angle at −90 degrees and a value obtained by subtracting half of the maximum diffraction angle at 90 degrees, wherein the maximum diffraction angle may be a positive value.

In an embodiment, the determining of whether the rotation angle of the polygon is included in the first section may include removing at least a part of the angular spectrum if it is determined that the rotation angle is not included in the first section.

In an embodiment, the determining of whether the rotation angle of the polygon is included in the first section may include recording a component traveling in the output direction of the spatial light modulator in the angular spectrum if it is determined that the rotation angle is not included in the first section.

In an embodiment, the determining of whether the rotation angle of the polygon is included in the first section may include: determining whether the rotation angle is included in a second section different from the first section if it is determined that the rotation angle is not included in the first section; and removing a component traveling in a direction opposite to the output direction of the spatial light modulator in the angular spectrum if the rotation angle is included in the second section, and recording a component traveling in the output direction of the spatial light modulator in the angular spectrum.

In an embodiment, the second section may include a section between a value obtained by subtracting half of the maximum diffraction angle at −90 degrees and a value obtained by adding half of the maximum diffraction angle at −90 degrees and a section between a value obtained by subtracting half of the maximum diffraction angle at 90 degrees and a value obtained by adding half of the maximum diffraction angle at 90 degrees, wherein the maximum diffraction angle may be a positive value.

In an embodiment, the determining of whether the rotation angle of the polygon is included in the first section may include: determining whether the rotation angle is included in a third section different from the first section if it is determined that the rotation angle is not included in the first section; and removing the angular spectrum if the rotation angle is included in the third section.

In an embodiment, the third section may include a section between −180 degrees and a value obtained by subtracting half of the maximum diffraction angle at −90 degrees, and a section between a value obtained by adding half of the maximum diffraction angle at 90 degrees and −180 degrees, wherein the maximum diffraction angle may be a positive value.

In an embodiment, the recording of the angular spectrum if it is determined that the rotation angle is included in the first section may include: determining whether the rotation angle is a specific value; shifting the angular spectrum so that the rotation angle becomes the specific value if it is determined that the rotation angle is not a specific value; and recording the shifted angular spectrum.

In an embodiment, the recording of the angular spectrum if it is determined that the rotation angle is included in the first section may include: determining whether the rotation angle is a specific value; and recording the angular spectrum if the rotation angle is determined to be a specific value.

In an embodiment, the receiving of the distribution of the polygon and the generating of the angular spectrum based on the distribution of the polygon may include generating the angular spectrum by Fourier transforming the distribution of the polygon.

In an embodiment, the generating of the angular spectrum by Fourier transforming the distribution of the polygon may include: Fourier transforming the distribution of the polygon; and calculating a rotation matrix indicating rotation information of the polygon and a shift vector indicating a weight to be applied to a rotated frequency component based on the distribution of the polygon.

In an embodiment, the calculating of the rotation matrix indicating the rotation information of the polygon and the shift vector indicating the weight to be applied to the rotated frequency component based on the distribution of the polygon may include replacing a value of at least one element having a negative value among a plurality of elements of the rotation matrix with zero.

In an embodiment of the inventive concept, a hologram generation method includes: receiving a distribution of a polygon and generating an angular spectrum based on the distribution of the polygon; determining whether a rotation angle of the polygon is included in a first section determined based on a maximum diffraction angle of a spatial light modulator; and removing the angular spectrum if it is determined that the rotation angle is included in the first section.

In an embodiment, the determining of whether the rotation angle of the polygon is included in the first section may include recording at least a part of the angular spectrum if it is determined that the rotation angle is not included in the first section.

In an embodiment, the first section may include a section between −180 degrees and a value obtained by subtracting half of the maximum diffraction angle at −90 degrees, and a section between a value obtained by adding half of the maximum diffraction angle at 90 degrees and 180 degrees, wherein the maximum diffraction angle may be a positive value.

In an embodiment, the determining of whether the rotation angle of the polygon is included in the first section may include: determining whether the rotation angle is included in a second section different from the first section if it is determined that the rotation angle is not included in the first section; and recording a component traveling in a direction opposite to the output direction of the spatial light modulator in the angular spectrum if the rotation angle is included in the second section, and recording a component traveling in the output direction of the spatial light modulator in the angular spectrum, wherein the second section may include a section between a value obtained by subtracting half of the maximum diffraction angle at −90 degrees and a value obtained by adding half of the maximum diffraction angle at −90 degrees, and a section between a value obtained by subtracting half of the maximum diffraction angle at 90 degrees and a value obtained by adding half of the maximum diffraction angle at 90 degrees, wherein the maximum diffraction angle may be a positive value.

In an embodiment, the determining of whether the rotation angle of the polygon is included in the first section may include: determining whether the rotation angle is included in a third section different from the first section if it is determined that the rotation angle is not included in the first section; and recording the angular spectrum if the rotation angle is included in the third section, wherein the third section is a section between a value obtained by adding half of the maximum diffraction angle at −90 degrees and a value subtracting half of the maximum diffraction angle at 90 degrees, wherein the maximum diffraction angle may be a positive value.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a diagram illustrating a hologram generation device according to an embodiment of the inventive concept;

FIG. 2 is a diagram illustrating a case where a part of a polygon is covered by an obstacle;

FIG. 3 is a diagram illustrating a case where a polygon is not observed depending on the observation position;

FIGS. 4A and 4B are diagrams illustrating a method of processing a back face based on components of angular spectrum traveling to an observation position;

FIG. 5 is a diagram illustrating a method of generating a hologram according to an embodiment of the inventive concept;

FIG. 6 is a diagram illustrating first to third sections according to an embodiment of the inventive concept;

FIG. 7 is a diagram illustrating a method of generating a hologram in a first section of FIG. 6 by way of example;

FIG. 8 is a diagram illustrating a method of generating a hologram in a second section of FIG. 6 by way of example;

FIG. 9 is a diagram illustrating a method of generating a hologram in a third section of FIG. 6 by way of example;

FIG. 10 is a diagram for explaining an exemplary method of generating a hologram for shifting a recorded optical signal;

FIG. 11 is a diagram exemplarily illustrating a method of generating a hologram according to an embodiment of the inventive concept;

FIG. 12 is a diagram exemplarily showing a polygon generated according to an embodiment of the inventive concept;

FIG. 13 is a diagram illustrating a hologram generated according to an embodiment of the inventive concept;

FIG. 14 is a flowchart illustrating a method of generating a hologram according to an embodiment of the inventive concept;

FIG. 15 is a flowchart illustrating a method of generating a hologram according to an embodiment of the inventive concept; and

FIG. 16 is a flowchart illustrating an exemplary method of generating a hologram according to an embodiment of the inventive concept.

### DETAILED DESCRIPTION

In the following, embodiments of the inventive concept will be described in detail so that those skilled in the art easily carry out the inventive concept.

In the following, a first direction, a second direction, and a third direction are mentioned. The first direction may be a direction perpendicular to a traveling direction of a reference light signal outputted from a reference light generator of a hologram generation device. The second direction may be a direction perpendicular to the first direction. The third direction is perpendicular to a plane defined by the first and second directions, and may be a direction in which a polygon is observed.

FIG. 1 is a diagram illustrating a hologram generation device 100 according to an embodiment of the inventive concept. Referring to FIG. 1, the hologram generation device 100 is illustrated as an example. The hologram generation device 100 may be a device that generates a polygon PG based on interference of the modulated optical signals ML1 to MLN. The polygon PG may be a polygon (e.g., a triangle, a rectangle, and the like) representing at least a part of an object to be implemented as a hologram.

The hologram generation device 100 may include a reference light generator 110 and a spatial light modulator 120. The reference light generator 110 may output a reference light signal RL to the spatial light modulator 120. The reference light signal RL may be an optical signal having a constant luminous intensity.

The spatial light modulator 120 may receive a reference light signal RL from the reference light generator 110. The spatial light modulator 120 modulates the reference light signal RL to output a plurality of modulated optical signals ML1 to MLN. A polygon PG may be implemented based on interference of the plurality of modulated optical signals ML1 to MLN. The polygon PG may be observed in the third direction

In an exemplary embodiment, the spatial light modulator 120 may generate modulation information by recording an object to be expressed as a hologram. The modulation information may be information for controlling a traveling direction and luminous intensity of the reference light signal RL. The spatial light modulator 120 modulates the reference light signal RL based on the modulation information to output a plurality of modulated optical signals ML1 to MLN. That is, the hologram generation device 100 may perform a process of generating modulation information by recording an object to be expressed as a hologram before generating the polygon PG.

FIG. 2 is a diagram illustrating a case where a part of the polygon PG is covered by the obstacle OS. Referring to FIG. 2, occlusion in the inventive concept will be described. The occlusion may mean that a part of light outputted from a specific object is blocked by another object.

For example, when the polygon PG is implemented by the spatial light modulator 120 and an obstacle OS is located in the third direction of the polygon PG, the user of the hologram generation device can observe the polygon PG partially covered by the obstacle OS at the observation location. The range in which the polygon PG is covered may vary depending on the observation position.

FIG. 3 is a diagram illustrating a case where a polygon is not observed depending on the observation position. Referring to FIG. 3, the back face in the inventive concept will be described. The back face may mean a surface that is not observed depending on the observation position. The back face is similar to the occlusion in that it is not observed by the user at the observation location, but differs from the occlusion in the arrangement of objects and the processing method when generating a hologram.

The spatial light modulator 120 may generate a hologram HG based on the modulated optical signals. The hologram HG may include a first polygon PG1 and a second polygon PG2 spaced apart in the first direction. The optical signals constituting the first polygon PG1 may include a component traveling in the first direction. The optical signals constituting the second polygon PG2 may include a component traveling in a direction opposite to the first direction.

In an exemplary embodiment, the user may observe the first polygon PG1 at the first observation position. In this case, the user may not be able to observe the second polygon PG2 at the first observation position.

In an exemplary embodiment, the user may not observe both the first polygon PG1 and the second polygon PG2 at the second observation position.

In an exemplary embodiment, the user may observe the second polygon PG2 at the third observation position. In this case, the user may not be able to observe the first polygon PG1 at the third observation position.

As described above, even if the polygon is located in the same place, whether or not the polygon is observed may be changed according to the different observation location. Accordingly, in order to implement a hologram observed similar to an actual object, a hologram generation method to which a method of processing a back face is applied may be required.

FIGS. 4A and 4B are diagrams illustrating a method of processing a back face based on components of angular spectrum traveling to an observation position. Referring to FIG. 4A, when viewed from a second direction, a polygon PG rotated in a clockwise direction is shown. The polygon PG may be implemented as polygon light PGLa including at least one modulated optical signal outputted from the spatial light modulator 120.

In an exemplary embodiment, the polygon PG may be observed in a direction in which the polygon light PGLa travels. The polygon PG may be implemented on a plane, and for better understanding of the inventive concept, an observed portion is indicated as an unpainted area, and an unobserved portion is indicated as a colored area. For example, when viewing an unpainted area of the polygon PG in the direction in which the polygon light PGLa travels, the polygon PG may be observed. When viewing the colored area of the polygon PG in a direction opposite to the direction in which the polygon light PGLa travels, the polygon PG may not be observed.

In an exemplary embodiment, the hologram generation device may process the polygon light PGLa by dividing it into the first sub polygon light PGLa1 and the second sub polygon light PGLa2. The first sub-polygon light PGLa1 may be an optical signal traveling in a first direction. The second sub-polygon light PGLa2 may be an optical signal traveling in a third direction.

In an exemplary embodiment, the hologram generation device may process the back face so that the polygon PG is observed when the second sub-polygon light PGLa2 travels in the third direction. The user may observe the polygon PG at the first observation position. The first observation position is a position at which an object corresponding to the polygon PG is observed. That is, at the first observation position, the polygon PG is implemented similarly to an actual object.

However, the user can observe the polygon PG at the second observation position. The second observation position is a position at position an object corresponding to the polygon PG is not observed. That is, at the second observation position, the polygon PG is implemented differently from the actual object.

Referring to FIG. 4B, a polygon PG rotated in a counterclockwise direction when viewed from a second direction is shown. The polygon PG may be implemented as polygon light PGLb including at least one modulated optical signal outputted from the spatial light modulator 120.

In an exemplary embodiment, similar to FIG. 4A, the hologram generation device may process the polygon light PGLb by dividing it into a first sub-polygon light PGLb1 traveling in a first direction and a second sub-polygon light PGLb2 traveling in a direction opposite to the third direction.

In an exemplary embodiment, the hologram generation device may process the back face so that the polygon PG is not observed when the second sub-polygon light PGLb2 travels in a direction opposite to the third direction. The user may not be able to observe the polygon PG at the first observation position. The first observation position is a position at position an object corresponding to the polygon PG is not observed. That is, at the first observation position, the polygon PG is implemented similarly to an actual object.

However, the user may not be able to observe the polygon PG at the second observation position. The second observation position is a position at which an object corresponding to the polygon PG is observed. That is, at the second observation position, the polygon PG is implemented differently from the actual object.

As described above, according to the method of processing the back face based on the components of angular spectrum traveling to the observation position, in some embodiments, the polygon may be implemented differently from the actual object. Accordingly, in order to implement a hologram observed similar to a real object, a hologram generation method to which a back face processing technology different from the embodiments of FIGS. 4A and 4B is applied may be required.

FIG. 5 is a diagram illustrating a method of generating a hologram according to an embodiment of the inventive concept. Referring to FIG. 5, a method of recording a polygon PG by the spatial light modulator 120 will be described. The spatial light modulator 120 may generate modulation information by recording optical signals corresponding to a polygon PG. The spatial light modulator 120 may generate modulated optical signals by modulating a reference light signal based on the modulation information. The polygon PG may be implemented by interference of modulated optical signals. The polygon PG can be observed at the observation position.

In an exemplary embodiment, the spatial light modulator 120 may modulate a reference light signal in a finite diffraction range. For example, the spatial light modulator 120 may modulate a reference light signal traveling in the third direction so that the traveling direction changes within a diffraction range −θ_{SLM} to θ_{SLM}. In this case, the maximum diffraction angle θ_{SLM} may mean a maximum angle at which the spatial light modulator 120 can change the traveling direction of the reference light signal. The maximum diffraction angle θ_{SLM} may be a positive value.

In an exemplary embodiment, the spatial light modulator 120 may generate modulation information by recording optical signals corresponding to a polygon PG inclined by a rotation angle θ_{R}. In this case, the rotation angle θ_{R} may mean an angle in which the polygon PG is rotated clockwise from the reference plane REF parallel to the spatial light modulator 120 when viewed from the second direction. Embodiments of the case where the polygon PG is rotated will be described later with reference to FIGS. 7 to 9

According to an embodiment of the inventive concept, by dividing cases based on the maximum diffraction angle θ_{SLM} of the spatial light modulator 120 and the rotation angle θ_{R} of the polygon PG, and varying the method of recording polygons PG according to each case, a hologram generation method to which a back face processing technology that implements a hologram observed similar to an actual object is applied may be provided. The hologram generation method according to each case will be described later with reference to FIGS. 6 to 9.

FIG. 6 is a diagram illustrating first to third sections SEC1 to SEC3 according to an embodiment of the inventive concept. Referring to FIG. 6, first to third sections SEC1 to SEC3 determined based on the maximum diffraction angle θ_{SLM} of the spatial light modulator 120 are illustrated as an example. The rotation angle θ_{R} of the polygon PG may be included in any one of the first to third sections SEC1 to SEC3. Depending on the section in which the rotation angle θ_{R} of the polygon PG is included, a method of recording the polygon PG may vary.

The first section SEC1 may be a section between a value obtained by adding half of the maximum diffraction angle θ_{SLM} at −90 degrees and a value obtained by subtracting half of the maximum diffraction angle θ_{SLM} at 90 degrees. At this time, the maximum diffraction angle θ_{SLM} may be a positive value. A hologram generation method when the rotation angle θ_{R} of the polygon PG is included in the first section SEC1 will be described later with reference to FIG. 7.

The second section SEC2 may include a section between a value obtained by subtracting half of the maximum diffraction angle θ_{SLM} from −90 degrees and a value obtained by adding half of the maximum diffraction angle θ_{SLM} at −90 degrees. In addition, the second section SEC2 may include a section between a value obtained by subtracting half of the maximum diffraction angle θ_{SLM} from 90 degrees and a value obtained by adding half of the maximum diffraction angle θ_{SLM} at 90 degrees. At this time, the maximum diffraction angle θ_{SLM} may be a positive value. A hologram generation method when the rotation angle θ_{R} of the polygon PG is included in the second section SEC2 will be described later with reference to FIG. 8

The third section SEC3 may include a section between −180 degrees and a value obtained by subtracting half of the maximum diffraction angle θ_{SLM} at −90 degrees. In addition, the third section SEC3 may include a section between a value obtained by adding half of the maximum diffraction angle O_{SLM at} 90 degrees and 180 degrees. At this time, the maximum diffraction angle θ_{SLM} may be a positive value. A hologram generation method when the rotation angle θ_{R} of the polygon PG is included in the third section SEC3 will be described later with reference to FIG. 9.

FIG. 7 is a diagram illustrating a method of generating a hologram in the first section SEC1 of FIG. 6 by way of example. Referring to FIG. 7, a method of recording a polygon PG by the spatial light modulator 120 will be described. The rotation plane ROT including the polygon PG may be rotated clockwise by the rotation angle θ_{R} when viewed from the reference plane REF parallel to the spatial light modulator 120 in the second direction. In this case, the rotation angle θ_{R} may be included in the first section SEC1. The spatial light modulator 120 may record optical signals corresponding to the polygon PG through the recording area REC. The recording area REC may be an area in which an optical signal is recorded.

In an exemplary embodiment, when the rotation angle θ_{R} is included in the first section SEC1, as all the optical signals corresponding to the polygon PG include components traveling in the output direction (e.g., the third direction) of the spatial light modulator 120, the spatial light modulator 120 may record all optical signals corresponding to the polygon PG. For example, the spatial light modulator 120 may record optical signals traveling to the recording area REC.

In an exemplary embodiment, a process in which the spatial light modulator 120 records optical signals corresponding to the polygon PG may be implemented in software. In more detail, the hologram generation device including the spatial light modulator 120 may receive a distribution of polygons (PG). The hologram generation device can generate an angular spectrum by Fourier transforming the distribution of polygons PG. The hologram generation device can record angular spectrum.

For example, when the rotation angle θ_{R} is included in the first section SEC1, the hologram generation device can record all spectrums obtained by Fourier transforming the distribution of polygons PG without removing a part of angular spectrum.

FIG. 8 is a diagram illustrating a method of generating a hologram in the second section SEC2 of FIG. 6 by way of example. Referring to FIG. 8, a method of recording a polygon PG by the spatial light modulator 120 will be described. The rotation angle θ_{R} of the polygon PG may be included in the second section SEC2. The spatial light modulator 120 may record some of the optical signals corresponding to the polygon PG through the recording area REC. The spatial light modulator 120 may remove another part of the optical signals corresponding to the polygon PG through the deletion area DEL. The deletion area DEL may be an area in which the optical signal is not recorded despite the progress of the optical signal.

In an exemplary embodiment, when the rotation angle θ_{R} is included in the second section SEC2, as some of the optical signals corresponding to the polygon PG include a component traveling in the output direction (e.g., the third direction) of the spatial light modulator 120 and other some of the optical signals corresponding to the polygon PG include a component traveling in a direction opposite to the output direction of the spatial light modulator 120 (e.g., a direction opposite to the third direction), the spatial light modulator 120 may record some of the optical signals corresponding to the polygon PG and remove other parts.

For example, the spatial light modulator 120 may record optical signals traveling to the recording area REC. The spatial light modulator 120 may not record optical signals traveling to the deletion area DEL.

In an exemplary embodiment, a process in which the spatial light modulator 120 records optical signals corresponding to the polygon PG may be implemented in software. For example, when the rotation angle θ_{R} is included in the second section SEC2, the hologram generation device including the spatial light modulator 120 may generate an angular spectrum by Fourier transforming a distribution of a polygon PG. The hologram generation device can record components that travel in the third direction of the angular spectrum. The hologram generation device can remove components traveling in the opposite direction to the third direction in the angular spectrum.

FIG. 9 is a diagram exemplarily illustrating a method of generating a hologram in a third section SEC3 of FIG. 6. Referring to FIG. 9, a method of recording a polygon PG by the spatial light modulator 120 will be described. The rotation angle θ_{R} of the polygon PG may be included in the third section SEC3. The spatial light modulator 120 may remove optical signals corresponding to the polygon PG through the deletion area DEL.

In an exemplary embodiment, when the rotation angle θ_{R} is included in the third section SEC3, as all the optical signals corresponding to the polygon PG include a component traveling in a direction opposite to the output direction of the spatial light modulator 120 (e.g., a direction opposite to the third direction), the spatial light modulator 120 may remove all optical signals corresponding to the polygon PG. For example, the spatial light modulator 120 may not record optical signals traveling to the deletion area DEL.

In an exemplary embodiment, a process in which the spatial light modulator 120 records optical signals corresponding to the polygon PG may be implemented in software. For example, when the rotation angle θ_{R} is included in the third section SEC3, the hologram generation device including the spatial light modulator 120 can remove all the angular spectrum obtained by Fourier transform of the distribution of polygons PG.

FIG. 10 is a diagram for explaining an exemplary method of generating a hologram for shifting a recorded optical signal. Referring to FIG. 10, a hologram generation method for shifting a recorded optical signal is illustrated as an example. The spatial light modulator 120 may include an effective modulation area 121. The effective modulation area 121 may be an area in which the spatial light modulator 120 can physically output the modulated optical signal.

According to an embodiment of the inventive concept, a hologram generation method may be provided in which an optical signal outside the effective modulation area 121 is shifted into the effective modulation area 121. For example, a recording area REC in which optical signals corresponding to a polygon PG travel may deviate from the effective modulation area 121. Even if optical signals are recorded in the recording area REC, since the spatial light modulator 120 cannot output a modulated optical signal in a recording area REC outside the effective modulation area 121, it may not be possible to implement a polygon PG.

In this case, the spatial light modulator 120 may shift optical signals to be recorded in the recording area REC to the shifting recording area SREC. The spatial light modulator 120 may generate modulation information by recording optical signals shifted to the shifting recording area SREC. The spatial light modulator 120 may implement a polygon PG by outputting a modulated optical signal through the effective modulation area 121 based on the modulation information

In this case, the polygon PG implemented based on the optical signals traveling the recording area REC and the polygon PG implemented based on the optical signals traveling the shifting recording area SREC may be similar to each other when viewed from the observation position.

In an exemplary embodiment, the hologram generation device may shift optical signals corresponding to the polygon PG so that the polygon PG is parallel to the spatial light modulator 120. For example, regardless of whether the optical signals corresponding to the polygon PG are out of the effective modulation area 121, the hologram generation device may shift optical signals corresponding to the polygon PG so that the rotation angle of the polygon PG becomes a specific value (e.g., zero degrees). That is, the case where the shifting operation is performed in the inventive concept is not limited to the case where the optical signals corresponding to the polygon PG deviate from the effective modulation area 121.

In an exemplary embodiment, the hologram generation device may omit the shifting operation when the rotation angle of the polygon PG is a specific value. For example, when the rotation angle of the polygon PG is zero degrees, the hologram generation device may omit the shifting operation and record an optical signal corresponding to the polygon PG.

FIG. 11 is a diagram exemplarily illustrating a method of generating a hologram according to an embodiment of the inventive concept. Referring to FIG. 11, a method of recording and generating a polygon PG constituting a hologram by a hologram generation device is exemplarily described. The method of FIG. 11 may be implemented based on software, or may be implemented based on a combination of hardware and software.

The hologram generation device may receive a distribution of polygons PG. In an exemplary embodiment, the distribution of the polygon PG may be data expressed in local coordinates corresponding to the local plane LP defined by the fourth and fifth directions. The fourth direction may be a direction included in a plane in which the polygon PG is implemented. The fifth direction may be a direction perpendicular to the fourth direction.

The hologram generation device can generate an angular spectrum by Fourier transforming the distribution of polygons PG. In an exemplary embodiment, optical signals corresponding to an angular spectrum may be optical signals constituting a polygon PG that is not parallel to the spatial light modulator 120. Accordingly, an operation of shifting optical signals corresponding to the polygon PG so that the polygon PG is parallel to the spatial light modulator 120 may be required.

In an exemplary embodiment, the hologram generation device may calculate a rotation matrix indicating rotation information of the polygon PG and a shift vector indicating a weight applied to the rotated frequency component based on the distribution of the polygon PG. In more detail, the rotation matrix may be a matrix indicating a degree of rotation of the local plane LP with respect to the plane corresponding to the spatial light modulator 120. The shift vector may be a matrix including weights that are multiplied by frequencies in the first to third directions rotated based on the rotation matrix. The hologram generation device can perform an operation to shift an angular spectrum based on a rotation matrix and a shift vector.

$$G ( {f}_{x} , {f}_{y} ) = H ( {p}_{s} , {q}_{s} ) {e}^{j 2 π ( p \cdot {c}_{1} + q \cdot {c}_{2} + r \cdot {c}_{3} )} \frac{r}{{f}_{z}} \qquad [ Equation 1 ]$$

Equation 1 is an equation showing the relationship between the angular spectrum H and the angular spectrum G shifted to the effective modulation area. H is a Fourier transform value of the distribution of polygons PG expressed in local coordinates. G is a value obtained by shifting H to the effective modulation area pₛ is the value of H in the fourth direction qₛ is the value of H in the fifth direction fₓ, f_{y}, and f_{z} are frequencies in the first direction, the second direction, and the third direction of the optical signal corresponding to the polygon PG, respectively p, q, and r are values obtained by rotating fₓ, f_{y}, and f_{z} using a rotation matrix, respectively c₁, c₂, and c₃ are components of the shift vector in the first direction, the second direction, and the third direction, respectively.

$${f}_{z} = \sqrt{\frac{1}{{λ}^{2}} - {f}_{x}^{2} - {f}_{y}^{2}} \qquad [ Equation 2 ]$$

Equation 2 is an equation for calculating the frequency in the third direction of the optical signal corresponding to the polygon PG fₓ, f_{y}, and f_{z} are frequencies in the first direction, the second direction, and the third direction of the optical signal corresponding to the polygon PG, respectively. λ is a value corresponding to the wavelength of the optical signal. For example, λ may be a wavelength value in consideration of the medium through which the optical signal travels in the hologram generation device. By applying Equation 2, f_{z} used in Equation 1 can be derived.

$$[ \begin{matrix}p \\ q \\ r\end{matrix} ] = R \cdot [ \begin{matrix}{f}_{x} \\ {f}_{y} \\ {f}_{z}\end{matrix} ] = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] \cdot [ \begin{matrix}{f}_{x} \\ {f}_{y} \\ {f}_{z}\end{matrix} ] \qquad [ Equation 3 ]$$

Equation 3 is an equation for converting the frequency of the optical signal corresponding to the polygon PG using a rotation matrix fₓ, f_{y}, and f_{z} are frequencies in the first direction, the second direction, and the third direction of the optical signal corresponding to the polygon PG, respectively. R may be a matrix indicating the degree of rotation of the optical signal corresponding to the distribution of the polygon PG with respect to the output direction of the spatial light modulator 120. R may include a plurality of elements r₁₁ to r₃₃ corresponding to weights for each direction. By applying Equation 3, p, q, and r used in Equation 1 can be derived

In an exemplary embodiment, the hologram generation device replaces a value of a negative element among a plurality of elements r₁₁ to r₃₃ of the rotation matrix R with zero, so that a component traveling in a direction (e.g., a direction opposite to the third direction) opposite to the output direction of the spatial light modulator may be removed. In this case, among the plurality of elements r₁₁ to r₃₃ of the rotation matrix R, elements having positive values may be maintained as they are

pₛ=p−r₁₃/λ [Equation 4]

Equation 4 is an equation for obtaining a value in the fourth direction of the angular spectrum H of Equation 1. p is a value derived according to Equation 3. r₁₃ is an element of the first row and the third column of the matrix R of Equation 3. λ is a value corresponding to the wavelength of the optical signal. By applying Equation 4, pₛ used in Equation 1 can be derived.

qₛ=q−r₂₃/λ [Equation 5]

Equation 5 is an equation for obtaining a value in the fifth direction of the angular spectrum H of Equation 1. q is a value derived according to Equation 3. r₂₃ is an element of the second row and the third column of the matrix R of Equation 3. λ is a value corresponding to the wavelength of the optical signal. By applying Equation 4, qₛ used in Equation 1 can be derived.

As described above, according to an embodiment of the inventive concept, a method of receiving the distribution of polygons PG, Fourier transforming the distribution of polygons PG, calculating the rotation matrix and shift vector based on the distribution of the polygon PG, and generating angular spectrum information that can be processed by the spatial light modulator 120 based on a rotation matrix, a shift vector, and a Fourier transformed distribution may be provided.

FIG. 12 is a diagram exemplarily showing a polygon generated according to an embodiment of the inventive concept. Referring to FIG. 12, a first polygon PG1 and a second polygon PG2 generated according to an embodiment of the inventive concept are illustrated as an example. The first polygon PG1 may be implemented based on polygon light PGL1 traveling in a direction opposite to the first direction. The second polygon PG2 may be implemented based on the polygon light PGL2 traveling in the first direction.

The first and second polygons PG1 and PG2 implemented according to an embodiment of the inventive concept may be polygons implemented similar to an actual object. For example, the first polygon PG1 may not be observed at the first observation position. The second polygon PG2 may be observed at the first observation position. For example, the first polygon PG1 may be observed at the second observation position. The second polygon PG2 may not be observed at the second observation position.

That is, according to an embodiment of the inventive concept, unlike the case described in FIGS. 4A and 4B, in spite of the change of the observation position, a method of generating a polygon that is implemented similar to a real object may be provided.

FIG. 13 is a diagram illustrating a hologram HG generated according to an embodiment of the inventive concept. Referring to FIG. 13, an observation result of a hologram HG implemented according to an embodiment of the inventive concept is illustrated as an example. The hologram HG may include first to fourth polygons PG1 to PG4. Whether each of the first to fourth polygons PG1 to PG4 can be observed may vary depending on the observation position.

When the hologram HG is observed at the first observation position, some polygons PG1, PG2, and PG3 of the hologram HG may be observed. The observation result at the first observation position may be similar to the observation result of an actual object.

When generating a hologram using a general method (e.g., a method processing the back face based on the component of the angular spectrum traveling to the observation position), the hologram HG observed at the second observation position may be different from the actual object. For example, a second polygon PG2 that should not be observed at the second observation position may be observed. The fourth polygon PG4 to be observed at the second observation position may not be observed.

When the hologram is generated by the method of the inventive concept, the hologram HG observed at the second observation position may be similar to an actual object. For example, unlike the case where a hologram is generated by a general method, the second polygon PG2 may not be observed at the second observation position. Also, the fourth polygon PG4 may be observed at the second observation position.

As described above, according to an embodiment of the inventive concept, a method of generating a hologram HG implemented similar to a real object may be provided.

FIG. 14 is a flowchart illustrating a method of generating a hologram according to an embodiment of the inventive concept. Referring to FIG. 14, a method of generating a hologram is illustrated by way of example. In operation S110, the hologram generation device may receive a polygon distribution. The distribution of the polygon may include information corresponding to the optical signal of the polygon to be recorded.

In an exemplary embodiment, the hologram generation device may generate an angular spectrum by Fourier transforming a distribution of polygons in operation S110 In addition, the hologram generation device may calculate a rotation matrix indicating rotation information of a polygon and a shift vector indicating a weight applied to the rotated frequency component based on the distribution of polygons.

In an exemplary embodiment, the hologram generation device may calculate a rotation matrix indicating rotation information of the polygon in operation S110, and perform an operation of replacing a value of at least one element having a negative value with zero among a plurality of elements of the rotation matrix.

In operation S120, the hologram generation device may determine whether the rotation angle of the polygon is included in the first section. The rotation angle of the polygon may be an angle indicating a degree of rotation of a plane including a distribution of a polygon with respect to a plane corresponding to the spatial light modulator of the hologram generation device. The first section may be a section determined based on the maximum diffraction angle of the spatial light modulator of the hologram generation device. For example, the first section may be a section between a value obtained by adding half of the maximum diffraction angle at −90 degrees and a value obtained by subtracting half of the maximum diffraction angle at 90 degrees. In this case, the maximum diffraction angle may be a positive value.

If it is determined in operation S120 that the rotation angle of the polygon is not included in the first section, the hologram generation device may perform operation S121 of removing at least a part of the angular spectrum. For example, the hologram generation device can remove components traveling in the direction opposite to the output direction of the spatial light modulator. In an exemplary embodiment, the hologram generation device may replace a value of an element having a negative value among elements of a rotation matrix with zero

In operation S130, the hologram generation device may record an angular spectrum. In an exemplary embodiment, if it is determined that the rotation angle of the polygon is included in the first section in operation S120, the hologram generation device can record the angular spectrum obtained by Fourier transforming the distribution of polygons. In an exemplary embodiment, the hologram generation device may record an angular spectrum corresponding to the remainder except for the component removed in operation S121.

FIG. 15 is a flowchart illustrating a method of generating a hologram according to an embodiment of the inventive concept. Referring to FIG. 15, a method of generating a hologram is illustrated by way of example. In operation S210, the hologram generation device may receive a polygon distribution. In operation S222, the hologram generation device may determine whether the rotation angle of the polygon is included in the third section. The third section may be a section determined based on the maximum diffraction angle of the spatial light modulator of the hologram generation device. For example, the third section may include a section between −180 degrees and a value obtained by subtracting half of the maximum diffraction angle at −90 degrees. Further, the third section may include a section between a value obtained by adding half of the maximum diffraction angle at 90 degrees and 180 degrees.

If it is determined in operation S222 that the rotation angle of the polygon is included in the third section, the hologram generation device may perform operation S223 of removing an angular spectrum corresponding to the distribution of the polygon. That is, since a polygon having a rotation angle included in the third section cannot be observed, the hologram generation device can remove the polygon information

If it is determined in operation S222 that the rotation angle of the polygon is not included in the third section, the hologram generation device may perform operation S230 of recording at least a part of the angular spectrum. For example, a hologram generation device can record a component traveling in the direction of the output of the spatial light modulator. That is, an angular spectrum corresponding to a distribution of a polygon having a rotation angle that is not included in the third section may include a component traveling in the output direction of the spatial light modulator.

FIG. 16 is a flowchart illustrating an exemplary method of generating a hologram according to an embodiment of the inventive concept. Referring to FIG. 16, a method of generating a hologram is illustrated by way of example. In operation S310, the hologram generation device may receive a polygon distribution. In operation S320, the hologram generation device may determine whether the rotation angle of the polygon is included in the first section. If it is determined in operation S320 that the rotation angle of the polygon is not included in the first section, the hologram generation device may perform operation S322 of determining whether the rotation angle of the polygon is included in the third section. That is, the hologram generation device may determine which section of the first to third sections the rotation angle of the polygon belongs to through operations S320 and S322.

If it is determined in operation S322 that the rotation angle of the polygon is included in the third section, the hologram generation device may perform operation S323 of removing an angular spectrum corresponding to the distribution of the polygon.

If it is determined in operation S322 that the rotation angle of the polygon is not included in the third section (that is, when it is determined that the rotation angle of the polygon is included in the second section), the hologram generation device may perform operation S321 of removing a component traveling in a direction opposite to the output direction of the spatial light modulator among the angular spectrum obtained by Fourier transforming the polygon distribution. In this case, the angular spectrum from which some components are removed according to operation S321 may include a component traveling in the output direction of the spatial light modulator.

In operation S330, the hologram generation device may determine whether the rotation angle of the polygon is a specific value. For example, the hologram generation device may determine whether the rotation angle of the polygon is zero degrees (that is, whether the polygon is parallel to the spatial light modulator of the hologram generation device). Operation S330 may be performed when it is determined in step S320 that the rotation angle of the polygon is included in the first section or after operation S321 is performed.

If it is determined in operation S330 that the rotation angle of the polygon is not a specific value, the hologram generation device may perform operation S331 of shifting the angular spectrum so that the rotation angle of the polygon becomes a specific value (i.e., the polygon becomes parallel to the spatial light modulator of the hologram generation device). The operation of shifting the angular spectrum may be performed with reference to Equations 1 to 5 described above.

In an exemplary embodiment, when the rotation angle of the polygon is determined to be a specific value, the hologram generation device may omit operation S331 of shifting the angular spectrum. For example, if the rotation angle of the polygon is determined to be a specific value in operation S330, the hologram generation device may record the angular spectrum without performing a shift operation in operation S332.

In operation S332, the hologram generation device may record an angular spectrum. Operation S332 may be performed when it is determined in operation S330 that the angular spectrum is included in the diffraction range of the spatial light modulator or after operation S331 is performed. For example, when the rotation angle of the polygon is not a specific value, the hologram generation device may record the angular spectrum shifted in operation S331. For example, when the rotation angle of the polygon is a specific value, the hologram generation device may record the polygon distribution received in operation S310.

In an exemplary embodiment, when the rotation angle of the polygon is included in the second section, unlike that shown in FIG. 16, after performing operations S330 and S331 of shifting the angular spectrum corresponding to the polygon and then performing operation S321 of removing the component proceeding in the opposite direction, the hologram generation device may perform operation S332 of recording an angular spectrum. In this case, the specific value in operation S330 may be a value included in the first section.

As described above, according to an embodiment of the inventive concept, by dividing the cases based on the maximum diffraction angle of the spatial light modulator and the rotation angle of the polygon, and differently applying a method of recording the angular spectrum corresponding to the distribution of the polygon, a method of generating an observed hologram similar to a real object may be provided.

According to an embodiment of the inventive concept, by recording the polygon based on the maximum diffraction angle and the rotation angle of the polygon of the spatial light modulator, a mesh-based hologram generation method is provided to implement a hologram that is observed similar to a real object despite the change of the observation position.

In addition, by excluding an unobservable angular spectrum from calculation, a computational speed is improved, and a mesh-based hologram generation method is provided to implement a hologram observed similar to a real object.

Although the exemplary embodiments of the inventive concept have been described, it is understood that the inventive concept should not be limited to these exemplary embodiments but various changes and modifications can be made by one ordinary skilled in the art within the spirit and scope of the inventive concept as hereinafter claimed.

What is claimed is:

1. A hologram generation method comprising:
receiving a distribution of a polygon and generating an angular spectrum based on the distribution of the polygon;
determining whether a rotation angle of the polygon is included in a first section determined based on a maximum diffraction angle of a spatial light modulator; and
recording the angular spectrum if it is determined that the rotation angle is included in the first section.

2. The method of claim 1, wherein the first section is a section between a value obtained by adding half of the maximum diffraction angle at −90 degrees and a value obtained by subtracting half of the maximum diffraction angle at 90 degrees,
wherein the maximum diffraction angle is a positive value.

3. The method of claim 1, wherein the determining of whether the rotation angle of the polygon is included in the first section comprises removing at least a part of the angular spectrum if it is determined that the rotation angle is not included in the first section.

4. The method of claim 1, wherein the determining of whether the rotation angle of the polygon is included in the first section comprises recording a component traveling in the output direction of the spatial light modulator in the angular spectrum if it is determined that the rotation angle is not included in the first section.

5. The method of claim 1, wherein the determining of whether the rotation angle of the polygon is included in the first section comprises:
determining whether the rotation angle is included in a second section different from the first section if it is determined that the rotation angle is not included in the first section; and
removing a component traveling in a direction opposite to the output direction of the spatial light modulator in the angular spectrum if the rotation angle is included in the second section, and recording a component traveling in the output direction of the spatial light modulator in the angular spectrum.

6. The method of claim 5, wherein the second section comprises a section between a value obtained by subtracting half of the maximum diffraction angle at −90 degrees and a value obtained by adding half of the maximum diffraction angle at −90 degrees and a section between a value obtained by subtracting half of the maximum diffraction angle at 90 degrees and a value obtained by adding half of the maximum diffraction angle at 90 degrees,
wherein the maximum diffraction angle is a positive value.

7. The method of claim 1, wherein the determining of whether the rotation angle of the polygon is included in the first section comprises:
determining whether the rotation angle is included in a third section different from the first section if it is determined that the rotation angle is not included in the first section; and
removing the angular spectrum if the rotation angle is included in the third section.

8. The method of claim 7, wherein the third section comprises a section between −180 degrees and a value obtained by subtracting half of the maximum diffraction angle at −90 degrees, and a section between a value obtained by adding half of the maximum diffraction angle at 90 degrees and −180 degrees,
wherein the maximum diffraction angle is a positive value.

9. The method of claim 1, wherein the recording of the angular spectrum if it is determined that the rotation angle is included in the first section comprises:
determining whether the rotation angle is a specific value;
shifting the angular spectrum so that the rotation angle becomes the specific value if it is determined that the rotation angle is not a specific value; and
recording the shifted angular spectrum.

10. The method of claim 1, wherein the recording of the angular spectrum if it is determined that the rotation angle is included in the first section comprises:
determining whether the rotation angle is a specific value; and
recording the angular spectrum if the rotation angle is determined to be a specific value.

11. The method of claim 1, wherein the receiving of the distribution of the polygon and the generating of the angular spectrum based on the distribution of the polygon comprises generating the angular spectrum by Fourier transforming the distribution of the polygon.

12. The method of claim 11, wherein the generating of the angular spectrum by Fourier transforming the distribution of the polygon comprises:
Fourier transforming the distribution of the polygon; and
calculating a rotation matrix indicating rotation information of the polygon and a shift vector indicating a weight to be applied to a rotated frequency component based on the distribution of the polygon.

13. The method of claim 12, wherein the calculating of the rotation matrix indicating the rotation information of the polygon and the shift vector indicating the weight to be applied to the rotated frequency component based on the distribution of the polygon comprises replacing a value of at least one element having a negative value among a plurality of elements of the rotation matrix with zero.

14. A hologram generation method comprising:
receiving a distribution of a polygon and generating an angular spectrum based on the distribution of the polygon;
determining whether a rotation angle of the polygon is included in a first section determined based on a maximum diffraction angle of a spatial light modulator; and
removing the angular spectrum if it is determined that the rotation angle is included in the first section.

15. The method of claim 14, wherein the determining of whether the rotation angle of the polygon is included in the first section comprises recording at least a part of the angular spectrum if it is determined that the rotation angle is not included in the first section.

16. The method of claim 14, wherein the first section comprises a section between −180 degrees and a value obtained by subtracting half of the maximum diffraction angle at −90 degrees, and a section between a value obtained by adding half of the maximum diffraction angle at 90 degrees and 180 degrees, wherein the maximum diffraction angle is a positive value.

17. The method of claim 14, wherein the determining of whether the rotation angle of the polygon is included in the first section comprises:
determining whether the rotation angle is included in a second section different from the first section if it is determined that the rotation angle is not included in the first section; and
recording a component traveling in a direction opposite to the output direction of the spatial light modulator in the angular spectrum if the rotation angle is included in the second section, and recording a component traveling in the output direction of the spatial light modulator in the angular spectrum,
wherein the second section comprises a section between a value obtained by subtracting half of the maximum diffraction angle at −90 degrees and a value obtained by adding half of the maximum diffraction angle at −90 degrees, and a section between a value obtained by subtracting half of the maximum diffraction angle at 90 degrees and a value obtained by adding half of the maximum diffraction angle at 90 degrees,
wherein the maximum diffraction angle is a positive value.

18. The method of claim 14, wherein the determining of whether the rotation angle of the polygon is included in the first section comprises:
determining whether the rotation angle is included in a third section different from the first section if it is determined that the rotation angle is not included in the first section; and
recording the angular spectrum if the rotation angle is included in the third section,
wherein the third section is a section between a value obtained by adding half of the maximum diffraction angle at −90 degrees and a value subtracting half of the maximum diffraction angle at 90 degrees,
wherein the maximum diffraction angle is a positive value.
